(19) United States
(12) Patent Application Publication
(10) Pub. No.: US 2018/0341440 A1
(43) Pub. Date: Nov. 29, 2018

(54) SYSTEM AND METHOD FOR ALLOWING CLOUD COMMUNICATION FOR NON-CLOUD ENABLED PRINTERS AND OTHER DEVICES

(71) Applicant: PROMEGA CORPORATION, Madison, WI (US)

(72) Inventors: Jason Gennaro, Madison, WI (US); Travis Phillips, Stoughton, WI (US); Mark Sehmer, Stoughton, WI (US); Jason Collins, Fitchburg, WI (US)

(21) Appl. No.: 15/605,590

(22) Filed: May 25, 2017

(51) Int. Cl. G06F 3/12; G06K 19/077; G06K 1/12

(52) U.S. Cl. CPC G06F 3/1209; G06K 19/07749; G06F 3/1285; G06F 3/1236; G06K 1/12

(57) ABSTRACT

A radio frequency identification (RFID) system can include, for example, a device configured to communicate with a printer and a cloud network. In some examples, the device is separate from the printer. The device can be configured to provide two-way communication with the cloud network and the printer, to receive a request from the cloud network, and to cause the printer to print based on the request.

### BACKGROUND

Printing radio frequency identification (RFID) tags can be a painstaking, manual process that involves setting up a printer and trying to reconcile the tags printed from one printer with other tags, if applicable, printed elsewhere in the system. Further, such printers typically involve manual setup and configuration. Moreover, no solution is provided that tracks printed tags with associated item data, which can be used for inventory management.

Further limitations and disadvantages of conventional and traditional approaches will become apparent to one of skill in the art, through comparison of such systems with the present disclosure as set forth in the remainder of the present application with reference to the drawings.

### BRIEF SUMMARY

Systems and methods for allowing cloud communication for non-cloud-enabled device such as printers or other devices, for example, are provided substantially as illustrated by and/or described in connection with at least one of the figures as set forth more completely in the claims.

Some embodiments of the present disclosure provide a device that allows most types of printers to be connected to a cloud system and to send and receive messages to and from the cloud system. Such a device would have many advantages, including allowing users on the cloud system to print tags and associate item data from anywhere in the world. In some embodiments, the device can be already be setup to be used with the associated printers, thereby requiring minimal installation by the customer. The device can also integrate the printer into the cloud system so that tag tracking (e.g., radio frequency identification (RFID) tag tracking) and inventory tracking, for example, are performed in the same system. In some embodiments, the cloud system can be expanded to maintain a database of tag and related information to allow the user to perform lookups and maintain knowledge or data from anywhere.

Various advantages, aspects, and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1A illustrates a first portion of a radio frequency identification (RFID) system according to certain embodiments of the present disclosure.

FIG. 1B illustrates a second portion of the RFID system according to certain embodiments of the present disclosure.

FIG. 2 illustrates a flow chart, according to certain embodiments, demonstrating the data flow and processes the RFID system uses to execute a demand on an RFID device for commands.

FIG. 3 illustrates a flow chart, according to certain embodiments, demonstrating processes the RFID system uses to update or manage the configuration of an endpoint application.

FIG. 4 illustrates a flow chart, according to certain embodiments, demonstrating processes relating to the receipt of events from the RFID device or the RFID system.

FIG. 5 illustrates a Cloud-enabled RFID system according to certain embodiments of the present disclosure.

The foregoing summary, as well as the following detailed description of certain embodiments, will be better understood when read in conjunction with the appended drawings. For the purpose of illustration, shown in the drawings are certain embodiments of the invention. It should be understood, however, that the present disclosure is not limited to the arrangements and instrumentalities shown in the attached drawings.

### DETAILED DESCRIPTION

Radio frequency identification (RFID) device implementation projects for the enterprise level can be highly complex and require relatively substantial shifts in processes and procedures enterprise wide. RFID devices can be installed throughout an enterprise for tracking a variety of items, products, and people. Further, RFID devices can be used by an enterprise throughout the distribution system and potentially into the point of use and/or consumption. Examples of RFID devices include fixed readers, label printers, handheld readers, and cell phones, among others, that have an antenna designed to emit a radio frequency that allows for reading information on RFID tags. These RFID devices can also include other, optional accessories, such as, for example, barcode readers or keypads, that can capture additional data when RFID tags are read.

The enterprise (e.g., the information technology department of the enterprise) is often tasked with figuring out how to get hundreds to thousands of RFID devices to communicate regionally, if not globally, to a central location, such as, for example, the headquarters of the enterprise. However, this process can be one of the more expensive aspects of deploying an RFID solution. In some uses, the RFID hardware can use a Low Level Reader Protocol (LLRP) to communicate RFID tag information. However, not all RFID devices support LLRP. Some RFID systems can use middleware software that assists in allowing the RFID devices to communicate with the software of the RFID system. However, in some cases, middleware software, which can be purchased or built for the RFID system, can increase the cost, maintenance, and/or complexity of the RFID system.

RFID systems can use a hardware and networking infrastructure that allows the RFID devices to be able to communicate with business application servers. For example, RFID systems can receive information or data from RFID devices that might need to be accessible so that the data contained therein can be acted upon by the business applications, such as, for example, in an enterprise resource planning (ERP) system. Thus, developers of RFID systems can be tasked with not only figuring out how to handle the desired RFID data, but also other events and processes involving the RFID data. Additionally, developers of such RFID systems might need to account for a variety of other issues, such as, for example, management of remote firmware, RFID device health, and the health of any peripherals connected to the RFID device. Further, business processes throughout an organization that utilize the RFID system might need to be concurrently updated for the new tracking ability that new, updated, or modified software can provide. The infrastructure for an RFID system might also need to be built in conjunction with the associated business software that utilizes data obtained by, or communicated through, the use of the RFID system, which can introduce another cost and/or delay point in some cases. In view of the foregoing, some RFID systems are not implemented due to the time and monetary investment in pure infrastructure costs.

RFID devices can have an application-programming interface (API) that is useful for local area network (LAN) segments. Thus, a local server connects to the RFID device via the API and then manages the functions of the RFID device, such as, for example, RFID scans, reboots of the RFID device, the health of the RFID device, and, potentially, firmware upgrades. However, in such examples, the API cannot be accessed over the Internet. Some RFID devices can have their own API that is either based on a proprietary protocol or an open source standard such as LLRP. Such protocols, however, can be designed for LAN communication only.

A typical setup of an RFID system, for example, is one that has a server on the same LAN network as the RFID devices. The server can connect to the RFID device and then control the functionality. Control of the RFID devices by the server is typically done over a specific transmission control protocol (TCP) port, such as, for example, TCP port number 5084 for LLRP. However, if a server needs to connect to the RFID devices that are on different LAN networks, then either a virtual private network (VPN) is used to bridge the different networks or a route over the Internet with a firewall-forwarding rule can be in place to make the connection between the different servers.

Some RFID devices can be dependent on being connected to a computer to operate or are built into a computer, such as, for example, a handheld barcode scanner. In these instances, the server can connect to the computer, or the computer can push data to the server. However, if the server needs to connect to the computer, the same problems can exist for communication across different networks.

Some embodiments of the present disclosure will now be described more fully with reference to the accompanying drawings. Some embodiments of the present disclosure can be embodied in many different forms and should not be construed as limited to the embodiments set forth herein. Rather, these certain embodiments are examples of the present disclosure, which has the full scope indicated by the language of the claims Like numbers refer to like elements throughout the application.

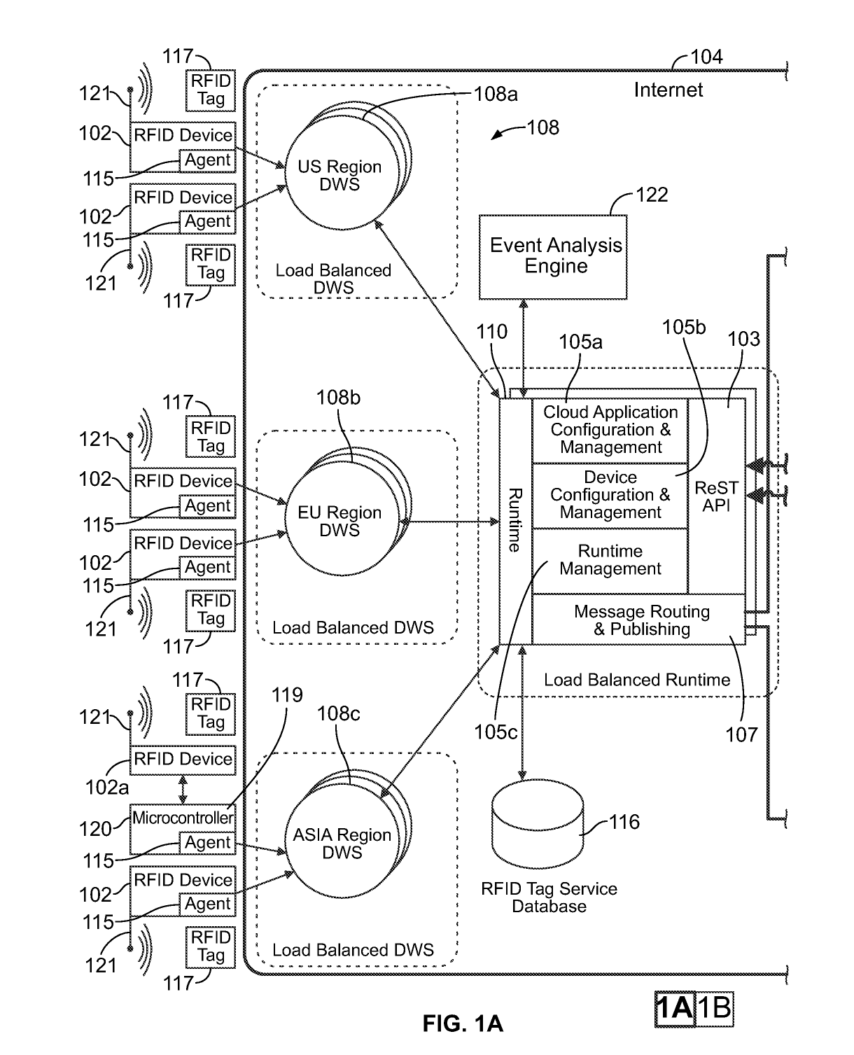

FIGS. 1A-B (“FIG. 1”) illustrate an RFID system 100 according to certain embodiments of the present disclosure. As shown, the RFID system 100 includes one or more RFID devices 102, a Cloud network 104, and one or more endpoint applications 106. As discussed below, each RFID device 102 can include, or be operated with, a local agent 115. The RFID device 102 can include an antenna 121, for example, that allows the RFID device 102 to communicate with an RFID tag 117. The RFID system 100 can be configured to provide an open Cloud device API and a Cloud application API 103 that is based in an application that is hosted on or run on the Cloud network 104. Use of the Cloud network 104 by the RFID system 100 can reduce or eliminate hardware and networking infrastructure constraints so as to allow RFID devices 102 to be able to communicate with an endpoint application 106, such as, for example, a business application. In fact, according to certain embodiments, the Cloud application API 103 can use standard API calls to perform a variety of tasks, such as, for example, query or set RFID data, query RFID device health or control RFID devices, regardless of hardware of the system 100.

Messages between the RFID device 102 and the Cloud network 104, the endpoint application 106 and the Cloud network 104, and/or within the Cloud network 104 can be done in context of a Cloud application 111a, 111b. A runtime system 110 of the Cloud network 104 can receive a message from a device web server (DWS) 108 and then can determine which Cloud application 111a, 111b and/or RFID device 102, and the information in the communication from the RFID device 102, is associated. Communications can then be published to all of the users of the Cloud application 111a, 111b and/or placed in the queue provided by the queuing service 114. Similarly, commands received via the Cloud application API 103 for an RFID device 102 are routed through the correct interface to the appropriate DWS 108, such as, in the illustrated embodiment, the regional DWS 108a, 108b, 108c that is communicating with the RFID device 102.

Data received from the RFID device 102 can be published, such as, for example, via a message routing and publishing application 107 of a runtime system 110 providing data for the Cloud application 111a, 111b. The particular Cloud application 111a, 111b that receives the data can depend on the content of the data and/or the RFID device 102 from which the data originated. More specifically, the Cloud application 111a, 111b can be associated with different endpoint applications 106 that subscribe to, or seek, particular types of data or data from particular RFID devices 102. Further, as illustrated by FIG. 1, the data delivered to the Cloud application 111a, 111b can be further filtered so that particular information can be delivered to some, but not all, endpoint applications 106 associated with the particular Cloud application 111b. As discussed below, the data received by the Cloud application 111a, 111b can be either directly delivered to an associated endpoint application 106 or into a queue of a queuing service 114 that the endpoint application 106 can use to either access or consume the returned data when needed.

The local agent 115 for the RFID device 102 can manage a number of functions of the RFID device 102, including, for example, RFID reading, health reporting, and firmware management, among other tasks. Further, the agent 115 is configured to push data from the RFID device 102 to the Cloud network 104. Thus, while according to certain embodiments, the agent 115 can also be configured to provide data in response to requests received from a server of the Cloud network 104, such as, for example, DWS 108. The agent 115 provides the ability for data on the RFID device 102 to be pushed onto the Cloud network 104 without a request for the data from the Cloud network 104, endpoint application 106, or other segment of the RFID system 100. Thus, the need for infrastructure, such as a VPN connection, typically used to establish a connection with a remote server at a satellite location and an RFID device 102 is not required. The RFID system 100 offers features to withstand intermittent component outages. When an endpoint application 106 seeks to obtain information regarding an RFID device 102 at a satellite location, such as, for example, a supplier seeking information regarding a product stored on consignment at an end user's facility, the current information that is provided by the RFID device 102 might already be available on the network. Therefore, in response to the endpoint application 106 of the supplier seeking information provided by the RFID device 102, the supplier's server is not required to establish a connection with the RFID device 102 through the end user's network or send an information request to the RFID device 102 through that connection. Instead, information available from the RFID device 102 might already have been pushed by the agent 115 onto the Cloud network 104. Additionally, the use of the agent 115 to push information onto the Cloud allows the system 100 to not need a remote server, such as, for example, the supplier's server, to control the RFID device 102, as the local agent 115 for the RFID device 102 handles such work.

The agent 115 can be a piece of software that runs directly on the RFID device 102. Alternatively, in the event the RFID device 102a does not include a microcontroller, an external processor device 119 having a microprocessor 120 with logic where the agent 115 can run is needed, such as, for example, a controlling computer or networked appliance. Further, the agent 115 is the interfacing software that acts as the exchange between the API of the RFID device 102 and the open Cloud device API that can reside at the DWS 108. Tasks for which the agent 115 can be responsible for include, but are not limited to: responding to device firmware and/or software updates and controls; generating a regularly scheduled message indicating the health of the RFID device 102; controlling configuration settings of the RFID device 102 and RFID reads; responding to configuration changes, such as, for example, RFID scan durations, RF power level, and RFID tag 117 reading sensitivity, among others; controlling when RFID scans occur, what settings are used, and the duration of RFID scans; providing feedback when RFID reads are occurring or if the RFID device 102 is experiencing a hardware problem; generating messages when error conditions occur; queuing messages if an Internet connection is not available; security authentication with the Cloud network 104; managing device time; and handling custom RFID device 102 specific commands and data.

According to certain embodiments, the agent 115 can communicate, through an Internet connection, with a DWS 108 of the Cloud network 104. The RFID device 102 and/or agent 115 can be configured to initiate the connection outbound from the network that the RFID device 102 is connected to a particular DWS 108. For example, FIG. 1 illustrates three different DWSs 108 that an RFID device 102 can communicate with, such as, for example, a United States (US) Region DWS 108a, European Union (EU) DWS 108b, and an Asia Region DWS 108c. As indicated by their names, according to certain embodiments, the particular DWS 108 that the RFID device 102 communicates with can be based on the location of the RFID device 102 and the DWS 108. However, different criteria can be used to determine which DWS 108 the RFID communicates with, such as, for example, the type of product or end user of the product associated with the RFID device 102, among other types of criteria.

Communication from, or between, the RFID device 102 and the DWS 108 can occur over a Secure Sockets Layer (SSL) connection using one or more ReST commands. According to certain embodiments, this communication is an HTTPS POST from the RFID device 102 to the DWS 108. Additionally, according to certain embodiments, to further augment the supply of data from the RFID device 102 to the DWS 108, a SOAP message or another proprietary messaging structure could be used to encapsulate the data. Further, according to certain embodiments, messages between the RFID device 102 and the DWS 108 can be in XML format.

According to certain embodiments, to enhance security, each agent 115 is configured with an access key registered in the RFID system 100, such as, for example, by the DWS 108. If the access key the agent 115 is reporting does not match the access key for that RFID device 102 and/or an access key registered by the RFID system 100, the communication from the agent 115 will be flagged as an error, which can result in the DWS 108 rejecting or ignoring the communication from the agent 115. Further, according to certain embodiments, a return communication can be sent to the RFID device 102, such as, for example, as an HTTP Error 401 with a message indicating that the access key provided by the agent 115 is invalid. This combination of an access key and the return message, such as the HTTP error message, provides security for messages being sent to the Cloud network 104 across the Internet, as well as security for the Cloud and endpoint application 111a, 111b, 106 that prevents spoofing or other malicious intent. Additionally, the receipt of the error by the agent 115 of the RFID device 102 can afford the agent 115 the opportunity to react to the message, such as by resending the access key or analyzing the access key being used.

The DWS 108 can be configured to be a relatively fast responding endpoint for communications, including communications providing data, to/from RFID devices 102. Therefore, according to certain embodiments, each DWS 108a, 108b, 108c can be multiple servers load balanced for optimal performance. Such load balancing can allow for maintenance on one or more DWSs 108 while other DWSs 108 handle the workload. Additionally, the system 100 can be configured to provide multiple DWS 108a, 108b, 108c availability zones that allows for failover if interruptions in network 104 connectively or other issues prevent one or more zones from being available. Thus, if an RFID device 102 is unable to connect with a DWS 108 in a particular territory, such as, for example, the US Region DWS 108a, communications to/from the RFID device 102 can be routed to another DWS 108, such as, for example, the EU Region DWS 108b. Further, the system 100 can also include a DNS load balancer for these multiple DWS 108a, 108b, 108c availability zones, such as the US Region DWS 108a, EU DWS 108b, and the Asia Region DWS 108c that provides one end point that agents 115 can connect to without the worry of managing failover and redundancy. Further, as previously discussed, the multiple DWS 108a, 108b, 108c zones can be set up regionally across the globe to allow RFID devices 102 to communicate with a DWS 108a, 108b, 108c that is in the same region as the RFID device 102, which can improve latency in network communications. Additionally, multiple RFID devices 102 can communicate with the DWS 108 at the same time, thereby allowing multiple messages to be sent to and/or received by the DWS 108 to improve the speed and efficiency of the system 100.

According to certain embodiments, when an RFID device 102 sends a communication to a DWS 108, and, if available, security is validated, the Cloud network 104 can return an acknowledgement to the RFID device 102 of successful receipt. For example, acknowledgement of a successful receipt of a communication can be sent to the RFID device 102 by issuing a HTTP 200 with an optional message, such as, for example, an acknowledgment message, which indicates that the RFID device 102 is not recognized, or to validate communications between the DWS 108 and the RFID device 102, among other messages. Once the RFID device 102, and more specifically the agent 115 of the RFID device, receives the acknowledgement, the agent 115 can proceed to remove the communication that was sent by the agent 115 of the RFID device 102 to the DWS 108 from the memory or queue of the RFID device 102 and proceed to send the next message, if there is one. According to certain embodiments, the above process can be repeated for each message. Alternatively, once the initial acknowledgment during a session of communication between the RFID device 102, and moreover its agent 115, and the Cloud network 104 is received, the agent 115 can communicate all remaining information or data that is ready to be communicated, such as, for example, by the SSL connection remaining open. As acknowledgements are received, the agent 115 of the RFID device 102 can then remove the sent messages from the RFID device 102. Once the agent 115 has finished sending messages and/or receiving acknowledgments, the SSL connection can be terminated or torn down.

The DWS 108 can also include a queue of commands that are to be delivered to the RFID device 102. When an RFID device 102 connects to a DWS 108 to communicate information to the DWS 108, the DWS 108 can inform the RFID device 102 that there are commands that the RFID device 102 needs to process. The DWS 108 can then send, via the Internet, the commands to the RFID device 102 for the RFID device 102 to act upon.

Communications received by the DWS 108 from the RFID devices 102 can be held in the DWS 108 for sending to a runtime system 110 of the Cloud network 104. In the event the runtime system 110 is unavailable, each DWS 108a, 108b, 108c can include a queue that holds the communications. The runtime system 110 can include software that is configured to control elements of the runtime system 110, such as, for example, application configuration and management 105a, which can be used to determine which Cloud application 111a, 111b and/or endpoint applications 106 that are to receive particular types of data received from the RFID devices 102, and/or which RFID devices 102 are to receive particular types of messages, among other tasks. Moreover, communications from RFID devices 102 that are registered with the RFID system 100 can be delivered to all users/endpoint applications 106 who/that, under the Cloud application 111a, 111b, are to receive, or have subscribed to, communications from the RFID device 102. Data cannot transverse across Cloud applications.

Additionally, elements controlled by the runtime system 110 can include, for example, RFID device 102 configuration and management 105b, such as, for example, device definitions and logical devices. Further, elements controlled by the runtime system 110 can also include, for example, runtime management 105c, which can include policies and overall management of the RFID system 100.

For example, as different RFID devices 102 can have different configurations, such as different settings, supported functions, and reporting abilities, among others, the application configuration and management 105a software of the runtime system 110 can include device definitions that are created to represent a physical device, such as a particular RFID device 102. Moreover, a new device definition is expected to be created for each RFID device 102 that the RFID system 100 can support. Thus, the runtime system 110 uses device definitions to validate a command(s), or request(s), that is/are being issued to the RFID device 102 to, for example, validate that the command(s) is/are compatible with the configuration of the RFID device 102. Such validation also allows for feedback to the user and/or the endpoint application 106 relatively quickly in the event a command originating from the endpoint application 106 or runtime system 110 is invalid or incompatible with the RFID device 102 that is the intended recipient of the command. Commands that can be validated by the runtime system 110 based on device definitions include, but are not limited to: RFID functions, such as, for example, kill tags, lock tags, unlock tags, write tag data, and read tag data; system functions, such as, for example, reboot, update firmware/software; configuration parameters, including, for example, name of supported parameters that can be get/set remotely as well as their type, such as bool, int, and double, among others; device specific commands, such as, extension methods used for specific functions to be controlled remotely outside of the standard RFID system 100 offering; and sensor controls, including, for example, a list of sensors each RFID device 102 can have along with the associated unit of measure for each sensor.

Additionally, each RFID device 102 might be required to be registered with the RFID system 100. According to certain embodiments, such registration might require a digital serial number that the RFID device 102 will send in communications with the RFID system 100. This digital serial number can be sent with the access key for the RFID device 102 and the XML message payload. The RFID system 100 can then map the digital serial number to a logical device in the runtime system 110. According to certain embodiments, the digital serial number assigned to the RFID device 102 can be permanent in that the RFID device 102 does not receive a different digital serial number, thereby allowing the digital serial number to provide a unique identifier across the RFID system 100. Additionally, when the RFID device 102 is registered, it can be tied in the runtime system 110 to a specific device definition, which can allow the RFID system 100 to validate communications before communications are sent to the RFID device 102. Endpoint applications 106 can also query device configurations so that proper settings and options for communication with the RFID device 102 are displayed to the end user.

Once an RFID device 102 is configured in the runtime system 110, the settings of the RFID device 102 can be managed with a policy, such as through the Cloud application configuration and management 105a software, used by the runtime system 100. Multiple RFID devices 102 can share a policy to allow for consistent settings across those RFID devices 102, while other RFID devices 102 can have different policies. Each policy can be tied to configuration parameters associated with the device definition for the RFID device 102, thereby restricting which parameters can be configured with default values of the appropriate type for the RFID device 102 associated with the policy. However, according to certain embodiments, at least some users and/or endpoint applications 106 can have the ability to override policy settings at the time the policy is applied to the RFID device 102.

The runtime system 110 can also run a high-level security object application in which RFID devices 102 might only belong to one Cloud application 111a, 111b. For example, a Cloud application 111a, 111b can be the main containing security object in the Cloud network 104 in that RFID devices 102, endpoint applications 111a, 111b, and their users, and policies, among other settings, are all tied to a specific Cloud application 111a, 111b. According to certain embodiments, information inside a Cloud application 111a, 111b might not be read by another application 111a, 111b, and changes to an application 111a, 111b might be contained only to that application 111a, 111b.

Each user or their endpoint application 106 can have their own access key that is used to issue commands to the Cloud application API 103. Unlike serial numbers for RFID devices 102, security audits might require that access keys of the end user, endpoint application 106, and/or of the agent 115 of the RFID device 102 be cycled. Security is then abstracted away from the digital serial number identifier in that the access key is used for security, while the digital serial number is used for system identification purposes. When agent 115 learns that its access key is no longer valid, it can establish a connection to the runtime 110 via the DWS 108 to acquire a new key. Security mechanisms would be put in place to only allow formerly valid agents 115 to request a new key. Potentially, for example, a time period of 24 hours could be put in place where the agent 115 would automatically qualify for a new access key without manual intervention.

The Cloud application 111a, 111b can include a publishing service, referred to as topic, that end users can subscribe to using a subscription service 112, which the RFID system 100 utilizes to deliver messages to the endpoint application 106 from the runtime system 110. According to certain embodiments, the subscription service 112 can utilize Amazon Simple Notification Service (SNS). However, the subscription service can take other forms, such as, for example, an HTTP Post back or a SOAP message, among others. Additionally, a queuing service or mechanism 114, such as, for example, Amazon Simple Queue Service (SQS), Amazon Simple DB (SDB), an RSS service, or Microsoft Message Queue (MS-MQ), can be configured to receive messages from the subscription service 112. This configuration allows the endpoint application 106 to have messages pushed directly into the endpoint application 106, as shown, for example, by the endpoint application 106 identified as “Support Application” in FIG. 1, or query the queue provided by the queuing service 114 for messages, as shown by the other endpoint applications 106 in FIG. 1.

The runtime system 110 is a multi-tenant platform setup to support a multitude of users and their associated endpoint applications 106. According to certain embodiments, commands issued by endpoint applications 106 are achieved by using a ReST based web service over HTTPS. The endpoint application 106 might be required to supply its access key when making a call to the Cloud application API 103. Calls from the endpoint application 106 that have an invalid access key can be returned as an Error 401, indicating the access key is invalid.

The Cloud application API 103 provides a standard interface for issuing commands to RFID devices 102 regardless of RFID devices 102 manufacturer. Examples of RFID device 102 commands include, but are not limited to: DeviceSpecificCommand, which issues a command that is unique to a particular RFID devices 102; ResetCommand, which issues a command requesting the RFID device 102 to reboot itself; UpdateFirmwareCommand, which issues a command requesting the RFID device 102 apply a specific firmware version; GetConfigValuesCommand, which issues a command requesting the RFID device 102 to send back the configuration parameters of the RFID device 102; SetConfigValuesCommand, which issues a command requesting the RFID device 102 to update one or more of its configuration parameters, with the Cloud device API validating that each of the parameters exist and are of the correct type via the device definition before accepting the request; GetEPCListCommand, which issues a command requesting the RFID device 102 perform an RFID scan and return the results of the scan to the Cloud network 104; ReadTagDataCommand, which issues a command requesting the RFID device 102 perform an RFID scan and return all data stored on an RFID tag 117, such as, for example, a tag identification (TID), an Electronic Product Code (EPC), and data stored in the user memory area of the RFID tag 117; WriteTagDataCommand, which issues a command requesting the RFID device 102 perform a write to one or more RFID tags 117, such as, for example, writing data relating to the EPC or custom data to be stored in the user memory area of the RFID tag 117; LockCommand, which issues a command requesting the RFID device 102 to issue a “Lock” command to one or more RFID tags 117, with the “Lock” so that data can no longer be written to the RFID tag(s) 117; UnlockCommand, which issues a command requesting the RFID device 102 to issue an “Unlock” command to one or more RFID tags 117, with the “Unlock” command unlocking an RFID tag 117 to allow for data to once again be written to the RFID tag 117; and, KillCommand, which issues a command requesting the RFID device 102 to issue a “Kill” command that makes an RFID tag 117 no longer respond to RFID commands.

The Cloud application API 103 provides a standard interface for issuing commands to configure a Cloud application 111a, 111b. Configuration commands the Cloud application API 103 can provide includes, but is not limited, to: AddLogicalDevice, which represents a physical RFID device 102 that the runtime system 110 uses to route commands, with a logical device being tied to a specific device definition to further instruct the runtime system 110 how to treat the RFID device 102; RemoveLogicalDevice, which removes the setup and routes for an RFID device 102 in the runtime system; GetConfiguration, which returns the runtime system 110 settings for the Cloud application as well as a list of all configured logical devices; GetDeviceDefinitions, which returns a list of all available device configurations the RFID system 100 supports, and in which a logical device would be added with a reference to its correct device definition; AddPolicy, which creates a policy in the runtime system 110 that is designed to manage the settings for a specific RFID device 102; RemovePolicy, which removes a specific policy from the runtime system 110; GetPolicies, which returns a list of all policies for the endpoint application; AddDeviceToPolicy, which informs the runtime system 100 that an RFID device 102 should be using the parameter values defined in the policy in conjunction with any overrides for its settings; and RemoveDeviceFromPolicy, which informs the runtime system 110 that the settings of an RFID device 102 that are defined in the policy need to be monitored for compliance.

The RFID system 100 also publishes event data from RFID devices 102 or derived events to all endpoint applications 106. As previously mentioned, events are published and either delivered directly to the endpoints application 106 through the subscription service 112 or pushed to a queue that the endpoint application 106 can then query from when needed. Communications sent to the queue of the queuing service 114 can have a variety of different formats, such as, for example, being sent in JavaScript Object Notation (JSON) or XML format, or being formatted text, among others.

Events can be generated by either the RFID device 102 or the Cloud application API 103. Such events can include, but are not limited to: AggregateEvent, which provides a list of RFID tags 117 that have either been moved since the last RFID read or are no longer present, and which can provide context to the present/not present, movement and directionality; ObjectEvent, which provides a list of RFID tags 117 the RFID device 102 scanned; HeartbeatEvent, which is a message generated by the RFID device 102 indicating it is actively communicating with the Cloud network 104; SensorReadingEvent, which is a message generated by the RFID device 102 that indicates non-RFID data, such as, for example, temperature or humidity, among other data; LogEntryEvent, which is a message generated by the RFID device 102 for health and diagnostic purposes, and which can include a severity level to better prioritize the message; CommandQueuedEvent, which is generated by Cloud application API 103 to indicate a command has been issued for an RFID device 102; CommandCompletionEvent, which is generated by the RFID device 102 indicating the requested CommandQueuedEvent has been completed either successfully or unsuccessfully; LogicalDeviceAddedEvent, which is generated by the Cloud application API indicating a new LogicalDevice was added to the Cloud application; LogicalDeviceRemovedEvent, which is generated by the Cloud application API 103 indicating a LogicalDevice was removed from the Cloud application; DeviceFailureEvent, which is generated by the Cloud application API 103 indicating a LogicalDevice has been placed into a failure state in Jetstream; and, DeviceRestoreEvent, which is generated by the Cloud application API 103 indicating a LogicalDevice has been removed from a failure state in the Cloud application API 103.

Additionally, depending on the need, endpoint applications 106 can be built to interface with an event, a command, or configuration interfaces. Moreover, different endpoint 106 applications can consume the same data. For example, an enterprise resource planning (ERP) system, such as Systemanalyse and Programmentwicklung (“System Analysis and Program Development”) (SAP), can automatically be configured to add RFID devices 102 as inventory locations. When AggregateEvents are received, SAP can then collect that data and either move the inventory automatically to a new warehouse/stocking location or even bill a customer. Further, for example, another endpoint application 106 can be a web based device health and management application. Other applications can include, for example, a vendor managed inventory application, point of sale application, field inventory tracking application, or an asset management application, among others.

According to certain embodiments in which the Cloud application API 103 is ReST based, the endpoint application 106 can call the Cloud network 104 using cURL, or an equivalent, to retrieve data for the endpoint application 106. However, according to other embodiments, an open source SDK can be created that allows the Cloud network 104 to be worked with as though the Cloud network 104 were an object. Calls to the Cloud network 104 could then be built and validated before a ReST call from the Cloud application API 103 is made to the endpoint application 106. Similarly, the XML responses can be returned as objects and acted upon more easily.

According to certain embodiments, messages in a queue of the queuing service 114 of a Cloud application 111a, 111b can be stored as a JavaScript Object Notation (JSON). However, the JSON standard might not be handy for applications outside of JavaScript. Thus, according to certain embodiments, a software development kit (SDK) takes a JSON message and converts the message into an object for use in the endpoint application 106. The SDK can be created for any language that supports calling a HTTP/S endpoint, such as, for example, C#, Java, PHP, Ruby, or other similar language.

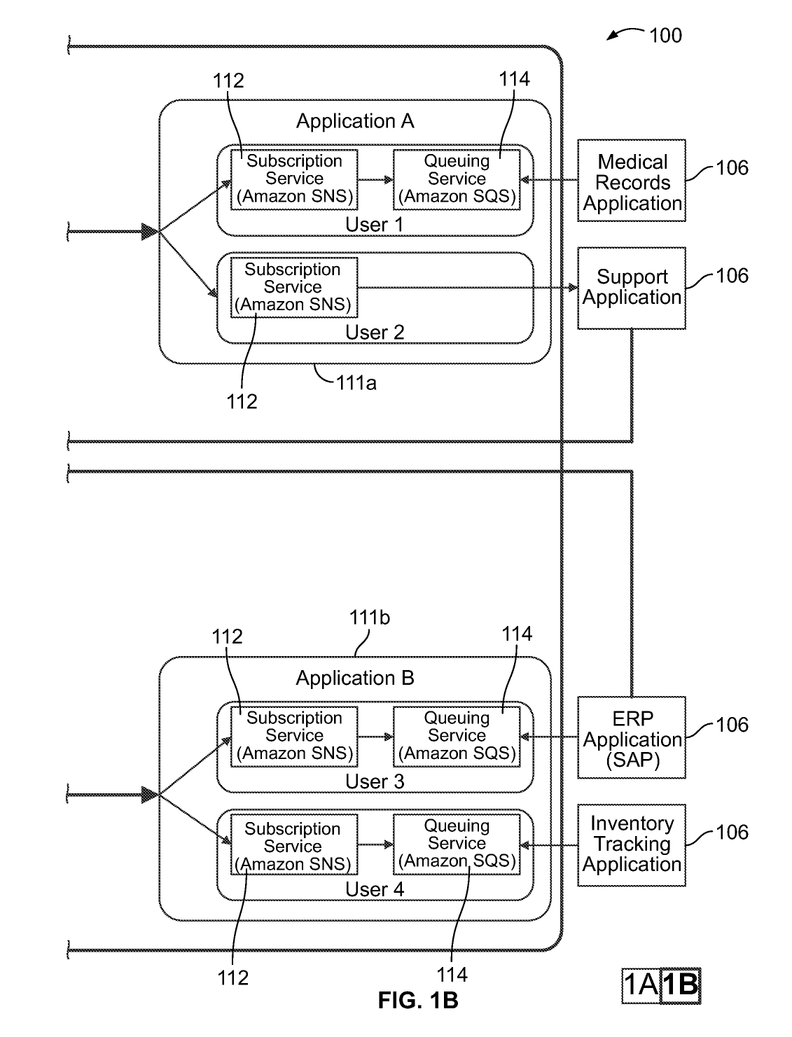

FIG. 2 illustrates a flow chart demonstrating the data flow and processes 200 the RFID system 100 uses to execute a demand on an RFID device 102 for commands according to certain embodiments. At step 202, an endpoint application calls the Cloud application API 103 with a desired, requested command. Again, according to certain embodiments, the Cloud application API 103 can be ReST based. At step 204, the Cloud application API 103 returns a unique CommandId in the CommandQueuedEvent that will identify the results on the CommandCompletionEvent. At step 206, the runtime system 100 examines the request command and identifies the DWS 108 that is communication with the RFID device(s) 102 subject to the command, and queues the requested command appropriately. At step 208, the RFID device 102 polls the DWS 108 for any requested commands. At step 210, the requested command is communicated from the DWS 108 to the RFID device 102. At step 212, the RFID device 102 executes the requested command, which can result in the generation results that reflect the execution of that command. At step 214, the results of the requested command are put into a CommandCompletionEvent with the CommandId and communicated to the DWS 108. At step 216, the DWS 108 sends the event, via the CommandCompletionEvent, to the runtime system 110. Then, at step 218, the runtime system 110 publishes the CommandCompletionEvent to the subscription service 112 for all subscribed SNS application users. At step 220, the endpoint application 106 consumes and processes the event.

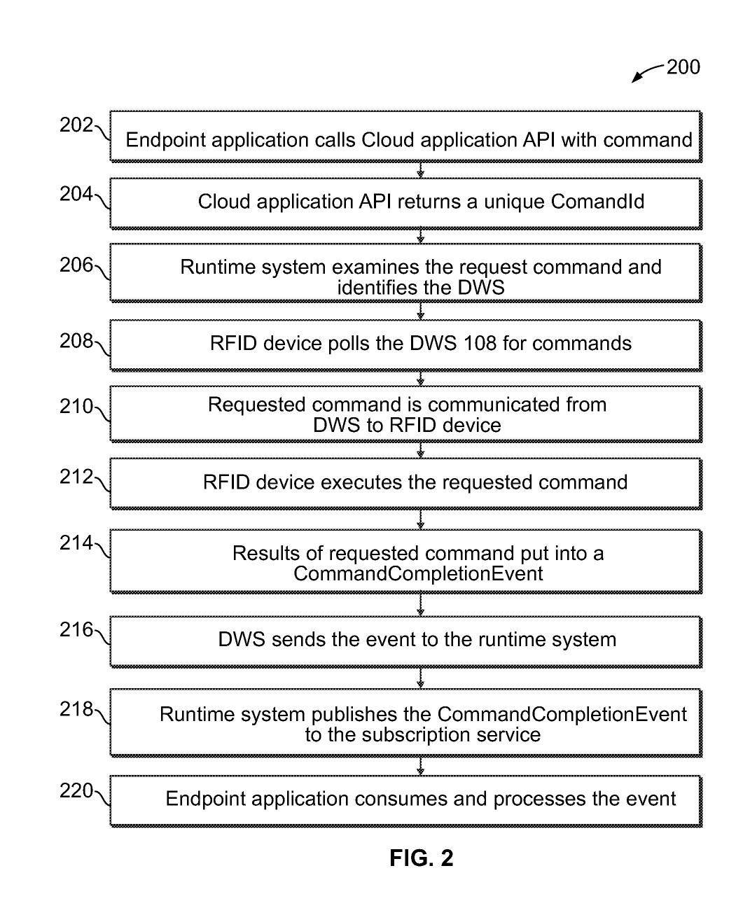

FIG. 3 illustrates a flow chart demonstrating processes 300 the RFID system 100 uses to update or manage the configuration of the Cloud application 111a, 111b. At 302, the endpoint application 106 calls the Cloud application API 103 with a configuration request. At step 304, the runtime system 100 receives the command via the Cloud application API 103. At step 306, the runtime system 110 performs the request. At step 308, the Cloud application API 103 returns a ConfigureResponse message, in the response to the configuration request, to the endpoint application 106 that indicates the success or failure of the command request, which can also include appropriate details.

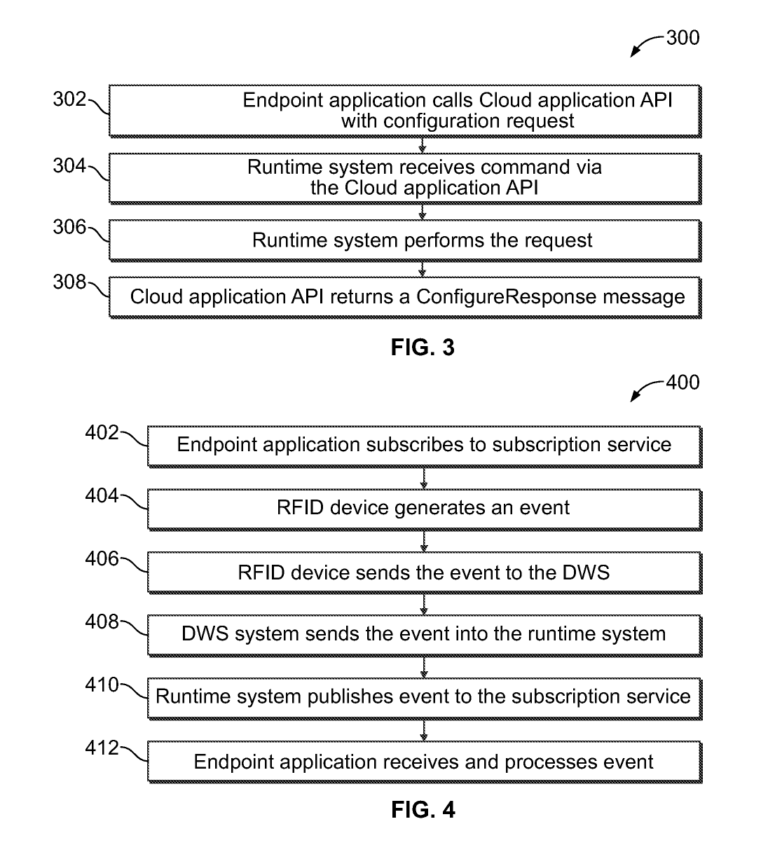

FIG. 4 illustrates a flow chart demonstrating processes 400 relating to the receipt of events from the RFID device 102 or the RFID system 100. At step 402, the endpoint application 106 subscribes to the subscription service 112, which will allow the endpoint application 106 to receive data relating to the RFID device 102. As previously mentioned, data can also be published directly to the RFID device 102 or be published in a queue of a queuing service 114. At step 404, the RFID device 102 generates an event, such as an AggregateEvent or LogEntryEvent. At step 406, the RFID device 102 sends the event to the DWS 108, such as, for example, over a SSL connection using a ReST command. At step 408, the DWS system 108 sends the event into the runtime system 110. Then, at step 410, the runtime system 110 publishes the event to all endpoint applications 106 that have subscribed to the subscription service 112 that receives the event. Once the event is with the subscription service at step 412, the endpoint application 105 can directly or indirectly receive and process the event.

According to certain embodiments, the RFID system 100 handles routing of data from RFID devices 102 to the correct endpoint application 106 without analyzing the data, with the possible exception of the endpoint applications 106. However, according to other embodiments, the RFID system 100 can include an event analysis engine 122 that is part of the runtime system 110. The event analysis engine 122 can take information, such as, for example, events, product quantity, time of event and/or changes in data, or a combination thereof, to create new LogEntryEvents. Similarly, a CommandQueuedEvent could automatically be scheduled, if desired. These rules would apply either application wide or based on a device definition of an RFID device 102.

For example, a rule can be set up application wide that monitors the last time a communication was received from an RFID device 102 and have an error condition of four hours. Thus, if an RFID device 102 ceases communication with a DWS 108, after four hours elapse, a LogEntryEvent can be generated indicating the RFID device 102 has not communicated in the last four hours. The LogEntryEvent can then be the basis for dispatching a support person to investigate the reason(s) for a lack of communication from the RFID device 102, such as, for example, the RFID device 102 having lost power. Additionally, for example, a rule can be set up in the device definition for RFID devices 102 for an application that monitors temperature changes over a period of time. Therefore, an RFID device 102 can report its temperature on a regular basis via a SensorReadingEvent. Additionally, the rule can be associated with various indication parameters, such as a rise or drop in temperature in a prescribed time period. Hence, if for example, a door to a freezer containing the RFID device 102 has been left open causing the temperature of the RFID device 102 to rise, such as by 10 degrees in 5 minutes, a LogEntryEvent can be generated indicating the warming trend. A support person could then be dispatched to close the door or remove the items if warranted. According to another example, a rule can be created application wide that monitors for an error condition, such as, for example, a software error. Thus, when an RFID device 102 is communicating but is sending in LogEntryEvents indicating a software problem, a ResetCommand can be triggered for the RFID device 102 to reboot to try to correct the software problem.

According to certain embodiments, communication between the RFID device 102 and the Cloud network 104 can be intermittent, such as, for example, occurring only at the specific times that the RFID device 102 seeks to communicate with the Cloud network 104. Thus, under such an example, the RFID device 102 might not receive a CommandQueuedEvent that has been generated by Cloud network 104 until the RFID device 102 communicates with the Cloud Network 104. In such situations, a relatively significant amount of time can elapse before the command is issued to the RFID device 102. However, to avoid such situations, according to certain embodiments, a communication channel that allows for bi-directional communication can be continuously open between the RFID device 102 and the Cloud Network 104. For example, when an RFID device 102 connects to a DWS 108, the DWS 108 would respond with options including the option of establishing a bi-directional communication channel between the RFID device 102 and the DWS 108. The RFID device 102 and the DWS 108 can then negotiate to see if such a connection could be established. Such negotiations can include latency and throughput to verify a stable connection could be established.

Once the bi-directional communication channel is established, events from the RFID device 102 can be sent to the Cloud network 104. Likewise, when the DWS 108 receives a command, the command would be sent directly to the RFID device 102 through the bi-directional channel for execution by the RFID device 102. The response from the RFID device 102 can then be returned to the DWS 108 on the acknowledgement of the command, or in instances in which the command will take a relatively long duration, the command would be returned to the DWS 108 when completed without having to establish outgoing communications. Further, in the event a bi-directional communication channel is established and the connection fails or drops, each side, namely the RFID device 102 and the DWS 108, would continue to operate in the RFID device 102 initiated connections mode with response back of queued commands.

According to certain embodiments, the bi-directional communication channel relies on technology similar to web sockets technology. For instance, the initial communication between the RFID device 102 and the DWS 108 can be negotiated over TCP ports 80/443, and eventually moved to a long-lived TCP port, which can be firewall friendly. According to such embodiments, since the upgraded socket has to be negotiated, the firewall is checked for compatibility as the socket is being set up.

With respect to RFID tag 117 validation, generally the identification information of an RFID tag 117 is typically only useful in conjunction with a database that ties the RFID tag 117 to the associated item. In some instances, this identification data can also be written to the user memory of the RFID tag 117. However, there are cases where the item associate with the RFID device 102 needs to be validated for its authenticity. According to certain embodiments of the present disclosure, such authenticity can be validated by using an interface to look up RFID tag 117 data from various external sources or via a built in tag registration service.

According to embodiments that utilize the built-in tag registration service, the Cloud device API would add functions to add RFID tag 117 and item information to a database 116 on the Cloud network 104 that would be managed through the Cloud device API. According to certain embodiments, the database 116 would be set up to have EPC and/or TID as indexes with a reference to the manufacturer of the product associated with the RFID tag 117. The database 116 can also contain a variety of information or fields, such as, for example, expiration date, lot, and/or batch number. Additionally, according to certain embodiments, such fields can be set-up in a database 116 that is separately based on the manufacturer. However, rather than being stored in a database 116 on the Cloud network 104, according to certain embodiments, the database 116 can be outside of the Cloud network 104 and accessible by a gateway service.

According to certain embodiments, a separate, non-management API with read only access is available to any endpoint application 106. Alternatively, for example, the API can also be accessed by anonymous users not registered in the runtime system 110. The request for this read only data from the RFID device 102 can originate from the endpoint application 106 or the associated user of the endpoint application 106. According to certain embodiments, the request can accept an EPC and/or a TID as the required bits of information for which data is to be returned. Data stored on the runtime system 110 relevant to the request can then be returned to the endpoint application 106, such as, for example, via a ReST based Cloud application API 103. The data can be displayed back to the endpoint application 106 as supplemental data. Similarly, for RFID tags 117 that have the same data written to the RFID tag 117, the RFID tag 117 can then be authenticated as valid, such as, for example, by validation through a comparison of certain information on the RFID tag 117 with information stored in the runtime system 110, such as, for example, a digital signature, expiration date, batch number, and/or lot number, among other information.

According to certain embodiments, to augment the built in tag registration service, a serialization option for the RFID system 100 can be provided. For example, RFID tags 117 may, or may not, initially be provided by a manufacturer with an EPC programmed on the RFID tag 117. However, this EPC can be inaccurate and/or not unique. Therefore, a request can be generated into a serialization service offered by the runtime system 110 for a new identifier for the RFID tag 117. The identifier returned from the serialization service can be unique to provide uniqueness for that identifier over all Cloud applications 111a, 111b utilizing the service offered by the application 111a, 111b. This can allow for RFID tags 117 to have context across multiple Cloud applications 111a, 111b without compromising application security.

Although embodiments of the present disclosure have been described as communicating information across the Internet, the RFID system 100 can also be configured to run on a local LAN. Such configurations can prevent data in the communication during operation of the of the RFID system 100 from passing outside an end user's organization. For such configurations, the DWS 108 and runtime system 110 can be packaged into pieces of software to be run on servers on premise of the end user. Although the RFID system 100 would not be operating across the Internet, the Cloud device API, which would be a local network API, would continue to be in communication with RFID devices 102 using the local area network. RFID devices 102 can therefore be configured to point to the local instance of the DWS 108, which might require the RFID device 102 have a configuration that indicates the network location of the DWS 108. Similarly, the endpoint application 106 would also use a local application API similar to the Cloud application API 103 that is on premise instead of through the Cloud, which might also require that the endpoint application 106 have a configuration that indicates where the network location of the appropriate API endpoint and queue.

Further, certain embodiments have been described as using a queuing service 114 through commands to the Cloud application API 103, such as ReST commands, with the results being returned via a publishing service 107, which can allow for a disconnected request-response view. Alternatively, a bidirectional communication channel can be established between the runtime system 110 and the endpoint application 106 that can prevent drops in communication when the endpoint application 106 connects to the runtime system 110 via the Cloud network API. Such a bi-directional communication channel can be more in line with client-server communication structures.

For example, when an endpoint application 106 connects to the Cloud application API 103, an option would be returned to the endpoint application 106 to upgrade to a bidirectional communication channel. The runtime system 110 and the endpoint application 106 then would negotiate to see whether such a bi-directional connection could be established. This negotiation can consider a variety of different factors, such as, for example, latency and throughput, to verify a stable connection could be established.

Once the bi-directional communication channel is established, commands are sent to the runtime system 110 as previously discussed. Events from RFID devices 102 are pushed relatively directly into the endpoint application 106. If the RFID device 102 is using a bi-directional communication channel to communication with the runtime system 110, as previously discussed, events can be sent to the endpoint application 106 in near real-time, typically with the delay being associated with network latency and the runtime routing. Similarly, commands issued by the endpoint application 106 to the RFID device 102 are received by the RFID device 102 in near real-time, with delay again typically being attributed to network latency and the runtime routing. In the event a bi-directional communication channel is established, and the connection fails or drops, the endpoint application 106 would return to receiving events from the message routing and publishing service 107 via the subscription service 112 or the queuing service 114. The endpoint application 102 would then be able to start the process over to reestablish the bidirectional communication channel.

Further, in the event a bi-directional communication channel is established with some endpoint applications 106, as the each network application is multi-tenant, the runtime system 110 might need to maintain a list of currently connected endpoint applications 106. Those endpoint applications 106 that are not actively connected to the Cloud network 104 can still have messages passed into the subscription service 112 or queuing service 114 via the publishing service 107 of the runtime system 110. For those endpoint applications 106 that are actively connected, the message would be pushed down the open bi-directional communication channel and not sent out for publishing for that user. To further the client/server relationship, when application-to-device is running in bi-directional mode, commands being executed against the RFID device 102 would have the results returned in the acknowledgement to the endpoint application 106.

In some embodiments, the agent 115 can be separate from or a part of the RFID device 102 or can be a part of a Cloud-enabled device that can be separate from the RFID device 102. The Cloud-enabled device can include one or more agents 115 or can use some other mechanism to enable another device (e.g., a non-Cloud-enabled device such as RFID devices, printers, displays, scanners, readers, etc.) to communicate with the Cloud through the Cloud-enabled device. Further, the Cloud-enabled device can be configured to support one or more RFID devices 102. In some embodiments, the agent 115 can be part of the Cloud-enabled device (e.g., integrated with, inserted into or attached to the Cloud-enabled device) to provide other devices (e.g., non-Cloud-enabled devices) access to the Cloud network 104.

In some embodiments, the Cloud-enabled device and/or the agent 115 can have plug-and-play capability so that the Cloud-enabled device can configure the agent 115, the agent 115 can configure the Cloud-enabled device, and/or each can configure the other, for example, upon detection of a connection between the Cloud-enabled device and the agent 115. In some embodiments, for example, where the Cloud-enabled device includes the agent 115, the Cloud-enabled device and/or a non-Cloud-enabled device can have plug-and-play capability so that the Cloud-enabled device can configure the non-Cloud-enabled device, the non-Cloud-enabled device can configure the Cloud-enabled device, and/or each can configure the other, for example, upon detection of a connection between the Cloud-enabled device and the non-Cloud enabled device.

In some embodiments, the agent 115 can be part of a computer or computing device that includes one or more processors and one or more nontransitory memories or storage devices. In some embodiments, the Cloud-enabled device that includes the agent 115 is a handheld or small Linux-based computer. The device can be configured to run a Linux operating system or another type of operating system.

In some embodiments, the RFID device can be RFID-enabled and, in other embodiments or modes, the RFID device is not RFID-enabled. In some embodiments, the RFID device can be Cloud-enabled and, in other embodiments or modes, the RFID device is not Cloud-enabled. In some embodiments, the RFID device 102 is configured to communicate with the Cloud-enabled device that includes the agent 115. In some embodiments, RFID device 102 can be an RFID tag printer or another type of printer, for example. In some embodiments, the RFID tag printer or other type of printer is not Cloud-enabled.

In some embodiments, the Cloud-enabled device that includes the agent 115 can be connected to the RFID device 102 by a wired link and/or a wireless link. For example, the Cloud-enabled device that includes the agent 115 can be connected to the RFID device 102 via a cable (e.g., a USB cable, a printer cable, an Ethernet cable, an I/O cable, a wire, etc.) and/or via wireless communication (e.g., IEEE 802.11 communication, Wi-Fi communication, Bluetooth communication, infrared communication, radio communication, MIMO connection, etc.). The Cloud-enabled device that includes the agent 115 can also be connected to the Cloud network 104 via wired link (e.g., a USB cable, a printer cable, an Ethernet cable, an I/O cable, a wire, etc.) and/or a wireless link (e.g., IEEE 802.11 communication, Wi-Fi communication, Bluetooth communication, infrared communication, radio communication, MIMO connection, Wi-Max communication, satellite communication, cellular communication, etc.). In some embodiments, the Cloud-enabled device that includes the agent 115 can be connected to the Cloud network 104 via at least the Internet and/or some other network.

In an exemplary embodiment, the Cloud-enabled device that includes the agent 115 or some other mechanism that enables Cloud communications for the Cloud-enabled device and other devices (Cloud-enabled or otherwise) operatively coupled to the mechanism includes a small Linux-based computer (e.g., handheld computer) or is configured to run a Linux operating system or other type of operating system (e.g., embedded PC); the RFID device 102 includes, for example, an RFID tag printer. The computer can be connected to the RFID tag printer via a USB cable, a Bluetooth wireless link, and/or other types of connections. Although the device connected to the computer is an RFID tag printer, the present disclosure contemplates other types of devices that are capable of communicating with the computer. Further, in some embodiments, the mechanism that enables Cloud communications for non-Cloud-enabled devices can be integrated with the non-enabled device. For example, the agent 115 or some other mechanism can be inserted into, integrated with, or connected to a non-Cloud-enabled RFID tag printer.

In some embodiments, the computer (e.g., Cloud-enabled computer) can be preconfigured. For example, a computer manufacture or software manufacture can configure the computer before the computer is purchased and/or deployed on-site. In an exemplary embodiment, the computer is preconfigured to work with the printer (or other devices such as non-Cloud-enabled devices) or can be configured before deployment by a third party. An image of the computer that is configured for the particular printer (e.g., non-Cloud-enabled printer) can be taken and then installed on any number of computers for deployment. This allows such computers to work with the installed device without further installation. This process can be repeated any number of times to support any number of devices. In some embodiments, the computer can be preconfigured or configured to support a plurality of printers. For example, the computer can be configured to support plug-and-play functionality in which the computer can connect (e.g., via a USB cable or a network connection) with the particular printer, identify (e.g., automatically identify) the particular printer and its capabilities, and automatically configured itself to communicate with and control the particular printer. In some embodiments, the computer or at least the mechanism (e.g., a device, an apparatus, a system, a computing engine, etc.) that enables Cloud communication for non-Cloud-enabled devices can be included or installed in the printer. In some embodiments, the computer and/or the mechanism can be configured to run a Linux operating system.

In some embodiments, the computer is configured to contact a Cloud-based service to send and receive messages. These messages can include, but are not limited to: a request to print tags, how many tags were printed, how many tags are left in the printer, the status of the printer, etc. If the computer receives a message involving the connected printer (or other device), the computer interacts with printer (or other device) to carry out the request in the received message. The computer subsequently reports the result of the request back to the Cloud-based service. The computer can also be configured to send (e.g., periodically send), without first receiving a request (e.g., an initial request) for particular data, one or messages that include the particular data to a Cloud-based service. In some embodiments, the computer can be configured to send messages based on, for example, customized communication schedules, calendar events, errors encountered, loss of connectivity with the device, printer events, etc.

Using the Cloud-based service according to some embodiments, a user or another application can request that an action be performed with respect to the printer (or other device) connected to the computer. For example, a request can cause a particular number of tags be printed with specific data printed on the label, but this is not the only use case. Requests can include different types of information including specific tag EPCs to encode, ranges of EPCs to encode, any kind of data to print on the tag, and any kind of metadata that is not used on the physical tag, but nonetheless is associated with and tracked with the tag. For example, a Cloud-based service can implement a self-serialization option for EPCs if the user or application does not specify any.

With respect to printers, some embodiments provide that labels be created and stored in a Cloud-based service to be referenced by requests to print. These labels can be of various sizes, material types, layouts, etc. This allows the devices connected to the Cloud-based service to use the same types of labels without having to individually set them up. Any printer on the Cloud-based service that can support the label can use that label. These labels can be created, edited, or deleted by the user or another application. In some embodiments though, due to security concerns, deletion of a label may not be possible. In some embodiments, applications may not be allowed to delete other applications. In some embodiments, templates can be created and stored in a Cloud-based service to be referenced by requests to print. In some embodiments, certain labels can include information such as a lot number that the computer or the Cloud-based service can use to identify what printer to use based on the label information.

Further, when a request to print tags is processed by the computer, the computer sends a message back to the Cloud-based service with the result of the request. The result can be a failure or error, for example, if there was an issue with printing, a success with the relevant information, or no result at all (e.g., Fire and Forget). The relevant information can include, but is not limited to: the number of tags printed, the EPCs of the printed tags, the information printed on the labels, the metadata passed to the computer, etc. The message from the computer can be sent out to other users on the Cloud network 104 or a Cloud-based service. The information can thus be tracked, stored, and accessed from different locations in or connected to the Cloud network 104.

Some embodiments provide that the Cloud network 104 or a Cloud-based service can keep a record of the relevant information. This allows users or other applications to look up EPCs and other data associated with the EPCs. This can include, but is not limited to: the particular printer that printed the tags, the information printed on the label, the metadata passed at the time of the printing, expiration dates, lot numbers, batch numbers, etc. In some embodiments, accessing this data or information is facilitated through a ReST-based API, a website, etc. In some embodiments, the RFID tag may already include EPC information, which might need to be overwritten or read and sent to the Cloud network 104.

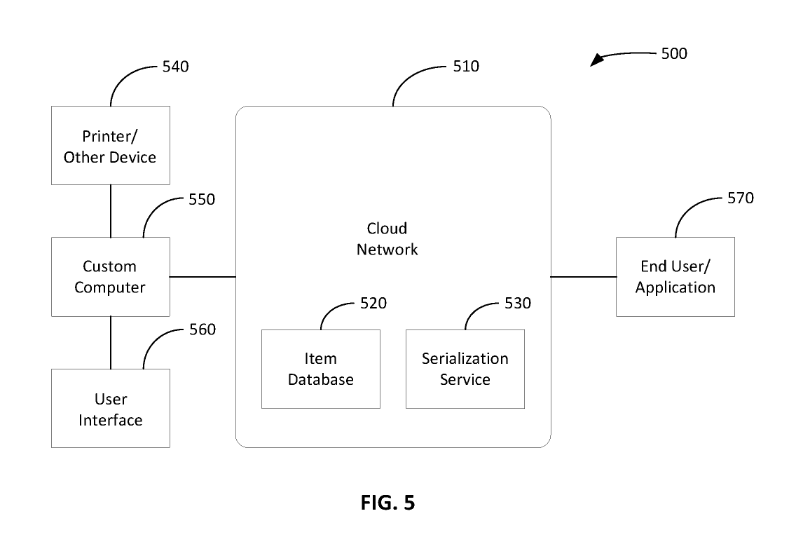

FIG. 5 shows a Cloud-enabled RFID system according to some embodiments of the present disclosure. The Cloud-enabled RFID system 500 can include, for example, one or more of the following: a Cloud network 510 that includes an item database 520 and a serialization service 530; a printer or other devices (e.g., Cloud-enabled devices and/or non-Cloud-enabled devices); a custom computer 550 that includes a mechanism that enables non-Cloud-enabled devices to become Cloud-enabled; a user interface 560 that is part of or connected to the custom computer 550; and an end user/application 570.

Referring to FIG. 5, the printer 540 (e.g., a non-Cloud-enabled device) is connected to the custom computer 550 (e.g., a Cloud-enabled device), which is connected to or includes the user interface 560. The custom computer 550 is connected to the Cloud network 510, which provides access to the item database 520 and the serialization service 530. The end user/application 570 is connected to the Cloud network 510.

In some embodiments, the custom computer 550, running custom code, for example, is connected to a printer or another device (e.g., non-Cloud-enabled device) that can connect with a computer. The custom computer 550 can send commands to the printer/device 540 and can receive messages back from the printer/device 540. The custom computer 550 can communicate with the printer/device 540, and/or the printer/device 540 can communicate with the custom computer 550, but both are not required.

The custom computer 550 can also be interfaced directly by a user via the user interface 560 using various inputs (e.g., a keyboard, a mouse, a monitor, a touch-screen, voice input, a scanner, a barcode scanner, a camera, etc.). Via the user interface 560, the user can send input commands to and change settings of the custom computer 550 and/or the printer/device 540 through the custom computer 550. Via the user interface 560, for example, the user can also instruct the custom computer 550 to send messages to the Cloud network 510. This is optional and is not required.

In some embodiments, the user interface 560 can be used to initiate a scan, a read, and/or a print of an RFID tag at the printer/device 540 via the custom computer 550. In some embodiments, the user interface 560 includes the scanner, camera, reader, etc. that is used to collect information that is sent to the customer computer 550, and/or the printer/device 540, and/or the Cloud network 510 via the custom computer 550. Further, the user interface 560 can be used to change settings or data in the custom computer 550 or the printer/device 540. For example, the user interface 560 can be used to enter data into the custom computer 550 that can be printed on a label at the printer/device 540. Further, the custom computer 550 can be configured to receive information from the user interface 560 and information from the Cloud network 510 and to instruct the printer/device 540 to print both information on the label (e.g., RFID label). In addition, the user interface 560 can be used to initiate reporting information about the printer/device 540 and/or the custom computer 550 to the Cloud network 510 and, if applicable, the end user/application 570 via the Cloud network 510.

In some embodiments, the custom computer 550 is designed to interact with a Cloud network 510. The Cloud network 510 can be hosted on the Internet or on a local server or network. The custom computer 550 can communicate with the Cloud network 510, and/or the Cloud network 510 can communicate with the custom computer 550, but both are not required. The custom computer 550 can receive messages (e.g., requests, commands, data, etc.) from the Cloud network 510 or from an end user/application 570 via the Cloud network 510. For example, the customer computer 550 can receive a message that includes a command and/or data to print one or more labels (e.g., RFID labels). The customer computer 550 can then cause the printer/device 540 to print the label in accordance with the command. The label may include, for example, the data (e.g., EPC information) received by the custom computer 550 from the Cloud network 510 and/or the user interface 560 and/or data stored in the custom computer 550. In addition, the custom computer 550 can send information to the Cloud network 510 including health/status information about the custom computer 550, health/status information about the printer/device 540, information about printed labels, label information, information relating to a sensed event (e.g., connectivity event, health, error, etc.) relating to the custom computer 550 and/or the printer/device 540, etc. Information related to the labels can include, for example, the number of RFID tags printed, the EPCs associated with the printed RFID tags, metadata related to each printed tag or item associated with each printed tag, etc. Information that can be included in the message received or sent include, for example, EPCs for encoding RFID tags, printed information, metadata that is not physically printed on the label or tag, etc.

In some embodiments, the Cloud network 510 can include, for example, the item database 520 that stores data provided by an end user/application 570, by the custom computer 550, or by a third party, for example. This data can be created, read, updated, and deleted by the end user/application 570 and/or the custom computer 550.

In some embodiments, the Cloud network 510 can include, for example, the serialization service 530 for use the customer computer 550 and/or the end user/application 570. The serialization service 530 can be used, for example, to control what electronic product codes, or other unique information, are encoded onto tags (e.g., RFID tags) to ensure that they are consistent with what the end user/application wants.

In some embodiments, the Cloud network 510 can communicate with an end user/application, and/or the end user/application can communicate with the cloud network, but both are not required. Via the Cloud network 510, the end user/application 570 can send commands to the custom computer 540, which can send them to the printer/device 540. Via the Cloud network 510, the end user/application 570 can also receive messages from the custom computer 550 or the printer/device (through the custom computer 540).

In some embodiments, the printer/device 540 can print data that is received from the Cloud network 510 via the custom computer 550, and/or data that is received from the user interface 560 (e.g., keyboard, barcode scanner, etc.) via the custom computer 550. Upon successfully printing the label (e.g., RFID label), the custom computer 550 and/or printer/device 540 via the custom computer 560 can report the successful printing or unsuccessful printing to the Cloud network 510, the user interface 560 (e.g., display), and/or the end user/application 570 via the Cloud network 510.

Other embodiments of the present disclosure can provide a non-transitory computer readable medium and/or storage medium, and/or a non-transitory machine readable medium, and/or storage medium, having stored thereon, a machine code and/or a computer program having at least one code section executable by a machine and/or a computer, thereby causing the machine and/or computer to perform the steps as described herein for a reflection coefficient reader.

Accordingly, aspects of the present disclosure can be realized in hardware, software, or a combination of hardware and software. The present disclosure can be realized in a centralized fashion in at least one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

Aspects of the present disclosure can also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes can be made and equivalents can be substituted without departing from the scope of the present disclosure. In addition, many modifications can be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A radio frequency identification (RFID) system comprising:
a mechanism operatively coupled to a device and a cloud network, wherein the device is not cloud-enabled, and wherein the mechanism is configured to:
communicate with the cloud network,
communicate with the device,
receive a message, and
interact with the device based on the message.

2. The RFID system according to claim 1, wherein the mechanism is configured to receive a message from the cloud network.

3. The RFID system according to claim 1, wherein the mechanism is configured to provide two-way or one-way communication with the cloud or the device.

4. The RFID system according to claim 1, wherein the mechanism is configured to provide two-way communication with the cloud or the device.

5. The RFID system according to claim 1, wherein the mechanism is configured to report information relating to the message to the cloud network.

6. The RFID system according to claim 1, wherein the device includes an RFID tag printer, and wherein the message includes a request for the RFID tag printer to print one or more RFID tags based on the request.

7. The RFID system according to claim 6, wherein the message includes electronic product code (EPC) information.

8. The RFID system according to claim 7, wherein, if an RFID tag of the one or more RFID tags already has EPC information, the RID tag printer overwrites the EPC information on the RFID tag with the EPC information in the message.

9. The RFID system according to claim 7, wherein, if an RFID tag of the one or more RFID tags already has EPC information, the RFID tag printer sends the EPC information of the RFID tag to the mechanism, and the mechanism sends the EPC information of the RFID tag to the cloud.

10. The RFID system according to claim 6, wherein the RFID tag printer is configured to send a message to the cloud network through the mechanism if the printer successfully prints the one or more RFID tags based on the request.

11. The RFID system according to claim 6, wherein the RFID tag printer is configured to send a message to the cloud network through the mechanism if the printer fails to print the one or more RFID tags based on the request.

12. The RFID system according to claim 10, wherein the message includes information relating to one or more of the following: a number of RFID tags printed, electronic product codes associated with the printed RFID tags, information printed on the one or more labels of the one or more RFID tags, metadata, and metadata related to each printed tag or a respective item associated with each printed RFID tag.

10. The RFID system according to claim 6, wherein the request includes information relating to one or more of the following: one or more electronic product codes for encoding the one or more RFID tags, a range of electronic product codes for encoding the one or more RFID tags, information to be printed on one or more labels on the one or more RFID tags, and metadata that is not physically printed on the one or more labels on the one or more RFID tags.

11. The RFID system according to claim 1, wherein the message comes from a user device or an application that is operatively coupled to or part of the cloud network.

12. The RFID system according to claim 11, wherein the application includes a cloud application or an endpoint application.

13. The RFID system according to claim 1, wherein the mechanism is configured to allow the device to communicate with the cloud network through the mechanism, and wherein the mechanism is configured to allow the cloud network to communicate with the device through the mechanism.

14. The RFID system according to claim 1, wherein the device includes a printer, wherein the mechanism is configured to allow the printer to communicate with a user device through the mechanism and through the cloud network, and wherein the mechanism is configured to allow the user device to communicate with the printer through the cloud network and through the mechanism.

15. The RFID system according to claim 1, wherein the cloud network is configured to store and track RFID tag information and associated item information.

16. The RFID system according to claim 1, wherein the mechanism is configured to send status information about the device to the cloud network, and wherein the sent status information is not in response to a request from the cloud network.

17. The RFID system according to claim 1, wherein mechanism is configured to initiate communication between the device and the cloud network.

18. The RFID system according to claim 1, wherein the device includes a printer.

19. The RFID system according to claim 18, wherein the mechanism is configured to work with a plurality of printers including the printer.

20. The RFID system according to claim 18, wherein the mechanism is configured to set up the printer facilitated by plug-and-play functionality when connected to the printer.

21. The RFID system according to claim 1, wherein the mechanism is configured to send information about the device to the cloud network in response to a sensed event relating to the device and not in response to a request from the cloud network.

22. The RFID system according to claim 21, wherein the sensed event includes one or more of the following: loss of connectivity with the device, device health, and device error.

23. The RFID system according to claim 1, wherein the mechanism is separate from the device.

24. The RFID system according to claim 1, wherein the mechanism is cloud-network enabled.

25. A radio frequency identification (RFID) system, comprising:
a device operatively coupled to a cloud network through a mechanism, wherein the device is not cloud-enabled, and wherein the mechanism is configured to:
communicate with the cloud network,
communicate with the device,
receive a first message from the cloud network,
interact with the device based on the first message,
receive a second message from a user interface, wherein the user interface is part of the mechanism or is operatively coupled to the mechanism, and
interact with the device based on the second message.

26. The RFID system according to claim 25, wherein the mechanism is configured to receive a third message from the device and to send the third message to the cloud network.

27. A radio frequency identification (RFID) system, comprising:
a device operatively coupled to a cloud network through a mechanism, wherein the device is not cloud-enabled, and wherein the mechanism is configured to:
communicate with the cloud network,
communicate with the device,
receive a message from a user interface, wherein the user interface is part of the mechanism or is operatively coupled to the mechanism, and
interact with the device based on the second message.

28. The RFID system according to claim 27, wherein the mechanism is configured to receive a third message from the device and to send the third message to the cloud network.
